(19) United States
(12) Patent Application Publication
(10) Pub. No.: US 2017/0321606 A1
(43) Pub. Date: Nov. 9, 2017

(54) AIRFLOW MANIPULATION DEVICE FOR COMPRESSOR

(71) Applicant: GENERAL ELECTRIC COMPANY, Schenectady, NY (US)

(72) Inventors: Sudhakar SOLTYSIUK, Bangalore (IN); Jakub SOLTYSIUK, Warsaw (PL); Sendilkumaran SOUNDIRAMOURTY, Bangalore (IN); Robert Cormack YOUNG, Warsaw (PL)

(21) Appl. No.: 15/522,943

(22) PCT Filed: Nov. 7, 2014
(86) PCT No.: PCT/US2014/064505

§ 371 Date: Apr. 28, 2017

(51) Int. Cl. F02C 7/18; F01D 5/08; F04D 19/02; F04D 29/32; F02C 3/04

(52) U.S. Cl. CPC F02C 7/18; F04D 29/321; F02C 3/04; F04D 19/02; F01D 5/085; F05D 2220/32; F05D 2260/2212; F05D 2260/60

(57) ABSTRACT

A compressor includes a purge flow extraction path extending radially and configured to direct an airflow radially inwardly. Also included is a center bore at least partially defined by a rotor structure extending axially and fluidly coupled to the purge flow extraction path. Further included is an airflow manipulation device disposed entirely within the center bore, the airflow manipulation device having a plurality of vanes defining at least one vane slot.

### BACKGROUND OF THE INVENTION

The subject matter disclosed herein relates to gas turbine systems, and more particularly to an airflow manipulation device for a compressor section of a gas turbine system.

Typically, in gas turbine systems, bucket supply secondary cooling airflow is extracted from a late stage of the compressor and directed radially inward through a flute, impellers, or a gap between compressor wheels. The airflow travels toward a center bore of the wheels. During the transition from the flute to the center bore, swirling vortices result and therefore an undesirably high pressure drop occurs within and proximate the center bore. A reduction of airflow swirling, and hence the pressure drop associated therewith would be advantageous.

### BRIEF DESCRIPTION OF THE INVENTION

According to one aspect of the invention, a compressor includes a purge flow extraction path extending radially and configured to direct an airflow radially inwardly. Also included is a center bore at least partially defined by a rotor structure extending axially and fluidly coupled to the purge flow extraction path. Further included is an airflow manipulation device disposed entirely within the center bore, the airflow manipulation device having a plurality of vanes defining at least one vane slot.

According to another aspect of the invention, a gas turbine engine includes a compressor section having a first wheel and a second wheel disposed adjacent to each other and a gap disposed between the first wheel and the second wheel wherein an airflow is directed radially inwardly within the gap. Also included is a combustion section and a turbine section. Further included is a rotor structure extending axially between, and operatively coupling, the compressor section and the turbine section. Yet further included is a center bore at least partially defined by the rotor structure and fluidly coupled to the gap, the center bore configured to receive the airflow. Also included is an airflow manipulation device disposed entirely within the center bore, the airflow manipulation device having a plurality of vanes defining at least one vane slot.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a perspective view of a forward side of a second wheel of a compressor section of the gas turbine engine;

FIG. 3 is a perspective view of a flow manipulation device;

FIG. 4 is a rear perspective view of the flow manipulation device;

FIG. 5 is a perspective view of the forward side of the second wheel illustrating the flow manipulation device with a back plate installed on the flow manipulation device; and

FIG. 6 is a perspective view of the flow manipulation device with the back plate installed thereon.

The detailed description explains embodiments of the invention, together with advantages and features, by way of example with reference to the drawings.

### DETAILED DESCRIPTION OF THE INVENTION

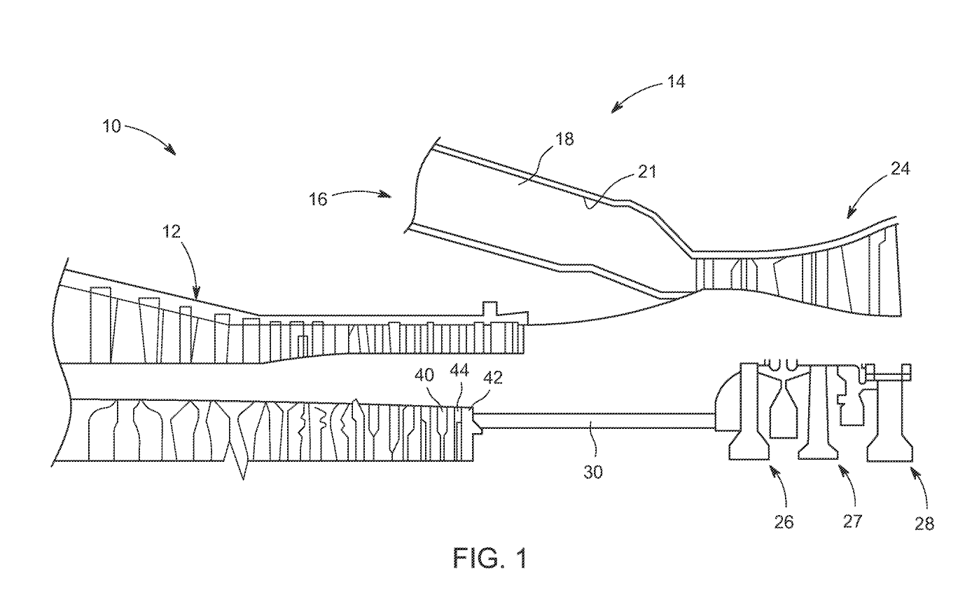

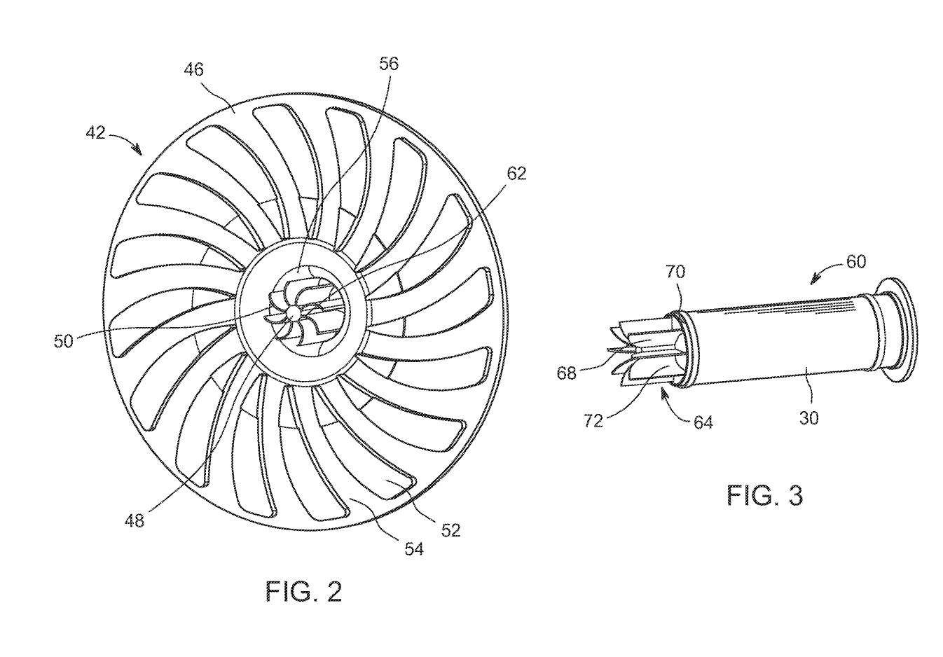

Referring to FIGS. 1 and 2, a turbine system, such as a gas turbine engine 10, constructed in accordance with an exemplary embodiment of the present invention is schematically illustrated. The gas turbine engine 10 includes a compressor section 12 and a plurality of combustor assemblies arranged in a can annular array, one of which is indicated at 14. The combustor assembly is configured to receive fuel from a fuel supply (not illustrated) through at least one fuel nozzle 20 (not shown) and a compressed air from the compressor section 12. The fuel and compressed air are passed into a combustor chamber 18 defined by a combustor liner 21 and ignited to form a high temperature, high pressure combustion product or air stream that is used to drive a turbine section 24. The turbine section 24 includes a plurality of stages 26-28 that are operationally connected to the compressor 12 through a rotor structure 30 (also referred to as a shaft).

In operation, air flows into the compressor 12 and is compressed into a high pressure gas. The high pressure gas is supplied to the combustor assembly 14 and mixed with fuel, for example natural gas, fuel oil, process gas and/or synthetic gas (syngas), in the combustor chamber 18. The fuel/air or combustible mixture ignites to form a high pressure, high temperature combustion gas stream, which is channeled to the turbine section 24 and converted from thermal energy to mechanical, rotational energy.

The compressor section 12 of the gas turbine engine 10 includes a plurality of wheels in a wheel space of the compressor section 12, to which compressor airfoils are mounted to for accelerating a main airflow through the gas turbine system and into the combustor assembly 14. The last two wheels that the airflow passes through are referred to as a first wheel 40 and second wheel 42. respectively. In a common gas turbine system, the compressor section 12 may include a plurality of wheels which includes two second wheels, thereby making the first wheel 40 correspond to the second to last wheel and the second wheel 42 correspond to the rearmost wheel. Irrespective of the precise number of wheels disposed within the compressor section 12, the wheels referenced are with respect to the last two wheels of the compressor section 12.

The first wheel 40 and the second wheel 42 are disposed within the compressor section 12 in a manner that forms an axial gap 44 between the two wheels, with the gap 44 extending radially inward from an outer radial location 46 that corresponds substantially to an outer diameter of the wheels. The gap 44 is configured to allow airflow from the outer radial location 46 toward a center axis 48 that extends axially through a center bore 50 of the second wheel 42. The wheels referred to herein are operatively coupled to other structures that together define the rotor structure 30. The center bore 50 extends axially along a main axis of the gas turbine engine 10 and is configured to fluidly couple the compressor section 12 to the turbine section 24, as will be described below. The airflow passes through the center bore 50 and towards the turbine section 24 containing a plurality of turbine wheels. Although the aforementioned description relates to the first wheel 40 and the second wheel 42 being disposed within the compressor section 12, it is to be understood that the wheels referred to may be disposed anywhere in the gas turbine engine 10, including but not limited to the turbine section 24. Furthermore, although described herein as extracting a purge flow from the region proximate the aft two wheels of the compressor section 12, one can appreciate that other locations of the compressor section 12 may be suitable for extraction.

The purge flow extraction path is at least partially defined by a gap between the first wheel 40 and the second wheel 42 that allows the airflow to travel radially inwardly to the center bore 50. In some embodiments, the purge flow extraction path comprises a circuit of numerous flow paths defined by structures of the first wheel 40 and/or the second wheel 42. For example, the second wheel 42 includes a plurality of impellers 52 that define at least one impeller slot 54. The number of impeller slots 54 is a function of how many impellers 52 are present, with each impeller slot 54 defined by adjacent pairs of impellers 52. The impeller slots 54 extend radially inward from a location proximate the outer radial location 46 toward the center bore 50 and may take on a curved configuration, as defined by the geometry of the impellers 52. Typically, the impeller slots 54 will extend to a location proximate an inlet 56 of the center bore 50. Each impeller 52 extends axially forward, or upstream, to directly contact or come in close contact with the first wheel 40. In the case of the impellers 52 directly contacting or abutting the first wheel 40, the airflow is solely transferred radially inward through the impeller slots 54.

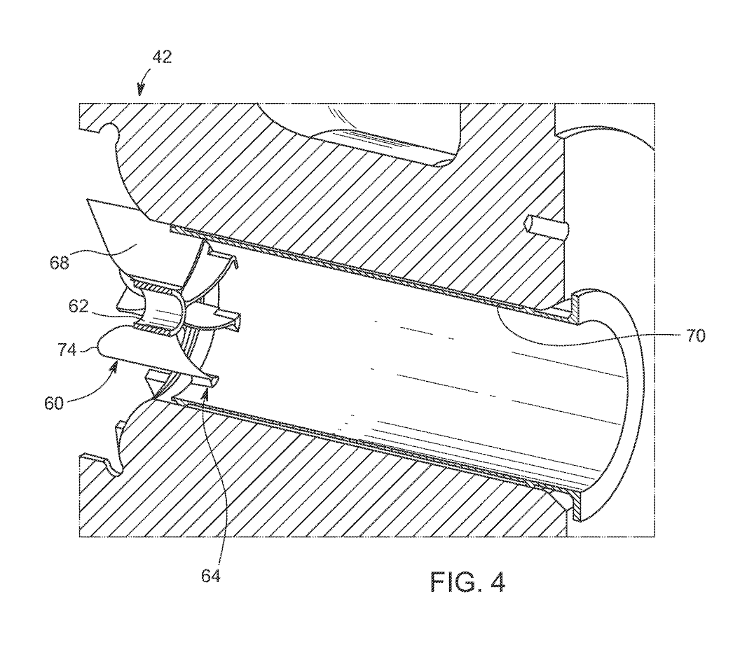

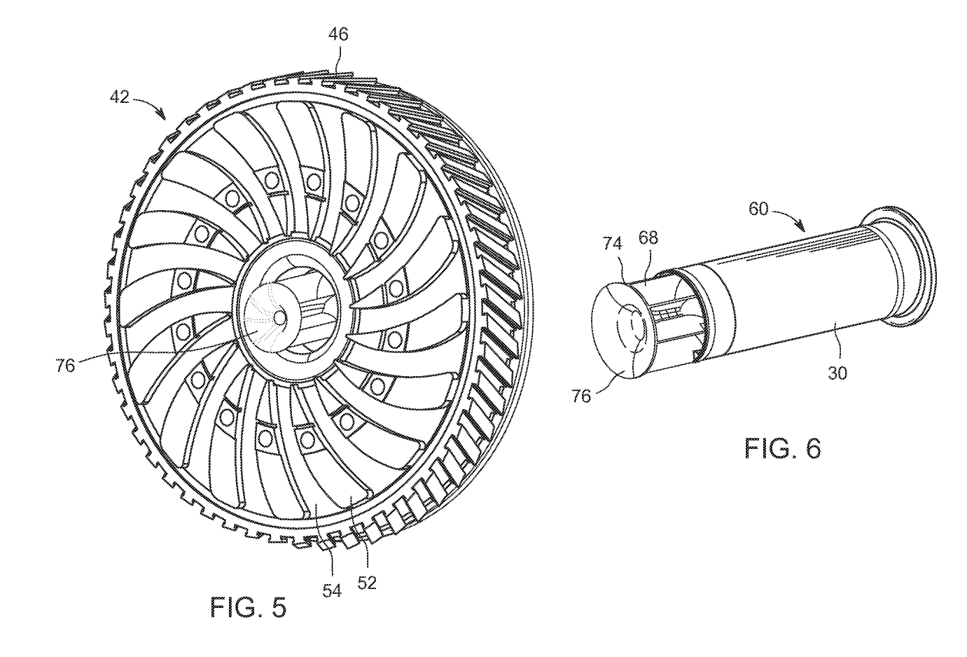

Referring now to FIGS. 3 and 4, an airflow manipulation device 60 having a central portion 62 and a vane portion 64 disposed within the central bore 50 proximate an aft region of the compressor section 12. The central portion 62 is substantially cylindrically shaped in the illustrated embodiment, but it is to be understood that alternative geometries may be employed. The vane portion 64 includes at least one, and typically a plurality of vanes 68 that extend radially outwardly from the central portion 62 within the center bore 50. The airflow manipulation device 60 and, more particularly, the plurality of vanes 68 have an outer radial dimension that is less than a radial dimension of the central bore 50, such that an outermost radial location of the airflow manipulation device 60 is located radially inwardly of a center bore wall 70 that defines the center bore 50. Such an arrangement ensures that the airflow manipulation device 60 is capable of being entirely disposed within the center bore 50, such that no portion of the airflow manipulation device 60 has a radial dimension greater than the center bore 50.

Advantageously, the airflow manipulation device 60 may be installed on existing compressor sections by simply retrofitting the compressor section 12. The relative geometries of the airflow manipulation device 60 and the center bore 50 facilitate installation of the airflow manipulation device 60 into the center bore 50 without the need for removal and disassembly of one or more components of the compressor section 12 and/or the rotor structure 30. In particular, an aft stub shaft, which is a portion of the rotor structure 30, would otherwise need to be removed and reinstalled to accommodate a flow manipulation device that does not fit entirely within the center bore 50.

The plurality of vanes 68 form at least one, but typically a plurality of vane slots 72 that function to serve as extensions of the at least one impeller slot 54, such that airflow rushing radially inward through the at least one impeller slots 54 smoothly transitions into the plurality of vane slots 72, and thereby into the center bore 50. The plurality of vanes 68 may be substantially straight along an axial length thereof, such that each of the plurality of vanes 68 is aligned in a single respective circumferential plane. Alternatively, as illustrated, at least one and up to all of the plurality of vanes 68 are curved in a circumferential direction along a portion of the axial length thereof. In some embodiments, the curvature extends along the entire length of the plurality of vanes 68.

In operation, a smooth deflection and transition of the airflow rushing inward toward the center bore 50 is established by the interaction of the plurality of vanes 68 and the impeller slots 54. As the airflow exits the at least one impeller slot 54, the airflow is directed into a first end 74 of the airflow manipulation device 60, which is positioned proximate the inlet 56 of the center bore 50 and proximate the first wheel 40 and the second wheel 42. In some embodiments, a plate 76 is operatively coupled to or integrally formed with the airflow manipulation device 60 and positioned proximate the first end 74 to facilitate the redirection of the airflow into the plurality of vane slots 72. Reduction of such swirling airflow advantageously reduces the pressure drop of the airflow as it passes into the center bore 50.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A compressor comprising:
a purge flow extraction path extending radially and configured to direct an airflow radially inwardly;
a center bore at least partially defined by a rotor structure extending axially and fluidly coupled to the purge flow extraction path; and
an airflow manipulation device disposed entirely within the center bore, the airflow manipulation device having a plurality of vanes defining at least one vane slot.

2. The compressor of claim 1, wherein the plurality of vanes are curved in a circumferential direction.

3. The compressor of claim 2, wherein the plurality of vanes are curved in a circumferential direction along an entire axial length thereof.

4. The compressor of claim 1, wherein the center bore is defined by center bore wall having a first radius and the airflow manipulation device includes an outer radius location having a second radius, wherein the first radius is greater than the second radius.

5. The compressor of claim 1, wherein the compressor further comprises a plurality of wheels, the center bore partially defined by a wheel bore of one of the plurality of wheels.

6. The compressor of claim 5, wherein the purge flow extraction path comprises a gap defined by a pair of adjacent wheels of the plurality of wheels.

7. The compressor of claim 5, wherein the purge flow extraction path comprises at least one impeller slot defined by a plurality of impeller blades of at least one of the plurality of wheels.

8. The compressor of claim 7, wherein a first end of the airflow manipulation device is disposed in close proximity to an outlet of the at least one impeller slot.

9. The compressor of claim 1, wherein the airflow manipulation device comprises a plurality of vane slots.

10. The compressor of claim 1, wherein the airflow manipulation device comprises a plate operatively coupled thereto, the plate having a funneled geometry configured to direct the airflow entering the airflow manipulation device.

11. The compressor of claim 1, wherein the airflow is a cooling flow and is routed through the center bore of the rotor structure to a turbine section of a gas turbine engine.

12. A gas turbine engine comprising:
a compressor section having a first wheel and a second wheel disposed adjacent to each other and a gap disposed between the first wheel and the second wheel wherein an airflow is directed radially inwardly within the gap;
a combustion section;
a turbine section;
a rotor structure extending axially between, and operatively coupling, the compressor section and the turbine section;
a center bore at least partially defined by the rotor structure and fluidly coupled to the gap, the center bore configured to receive the airflow; and
an airflow manipulation device disposed entirely within the center bore, the airflow manipulation device having a plurality of vanes defining at least one vane slot.

13. The gas turbine engine of claim 12, wherein the plurality of vanes are curved in a circumferential direction.

14. The gas turbine engine of claim 13, wherein the plurality of vanes are curved in a circumferential direction along an entire axial length thereof.

15. The gas turbine engine of claim 12, wherein the center bore is defined by center bore wall having a first radius and the airflow manipulation device includes an outer radius location having a second radius, wherein the first radius is greater than the second radius.

16. The gas turbine engine of claim 12, wherein the center bore is partially defined by a wheel bore at least one of the first wheel and the second wheel.

17. The gas turbine engine of claim 12, further comprising at least one impeller slot defined by a plurality of impeller blades of at least one of the first wheel and the second wheel, the at least one impeller slot configured to route the airflow to an inlet of the center bore.

18. The gas turbine engine of claim 17, wherein a first end of the airflow manipulation device is disposed in close proximity to an outlet of the at least one impeller slot.

19. The gas turbine engine of claim 12, wherein the airflow manipulation device comprises a plate operatively coupled thereto, the plate having a funneled geometry configured to direct the airflow entering the airflow manipulation device.

20. The gas turbine engine of claim 12, wherein the first wheel and the second wheel form the last two stages of the compressor section, wherein the compressor section is configured to be retrofitted with the airflow manipulation device due to relative radii of the center bore wall and the airflow manipulation device.
